(19) United States
(12) Patent Application Publication
(10) Pub. No.: US 2026/0287759 A1
(43) Pub. Date: Sep. 24, 2026

(54) INFORMATION PROCESSING METHOD, FIXED STATION, AND PROGRAM

(71) Applicant: SONY GROUP CORPORATION, TOKYO (JP)

(72) Inventors: RYO TAKAMORI, TOKYO (JP); SHOTA TAKAHASHI, TOKYO (JP); KENTARO IDA, TOKYO (JP)

(21) Appl. No.: 19/476,364

(22) PCT Filed: Apr. 2, 2024
(86) PCT No.: PCT/JP2024/013569

§ 371 Date: Oct. 17, 2025

(30) Foreign Application Priority Data
Apr. 28, 2023 (JP) 2023-074761

(51) Int. Cl. G01S 19/40

(52) U.S. Cl. CPC G01S 19/40

(57) ABSTRACT

An information processing method according to an embodiment of the present technology is an information processing method executed by a computer system, and includes detecting a state change of a fixed station which outputs correction data used in GNSS positioning on the basis of GNSS information received by the fixed station. When the state change of the fixed station is detected, at least one of notification processing for notifying of an occurrence of the state change of the fixed station or stop processing for stopping the output of the correction data is executed.

### TECHNICAL FIELD

The present technology relates to an information processing method, a fixed station, and a program applicable to positioning that uses a satellite positioning system (GNSS).

### BACKGROUND ART

From the past, there has been known a method in which correction data output from a fixed station is used in positioning of a mobile station that uses GNSS. This method is also called real-time kinematic (RTK), and by using the correction data, it becomes possible to perform relative positioning based on the fixed station, and thus improve positioning accuracy of the mobile station. Meanwhile, if the position of the fixed station changes, the positioning of the mobile station may become unstable. For this reason, a method of detecting a move of the fixed station and/or the like is being developed.

For example, Patent Literature 1 describes a method of detecting an anomaly in a reference station (fixed station) fixed at a reference point based on a traveling state of own vehicle equipped with a mobile station. In this method, an own-vehicle position is calculated from data received by the own vehicle from a GPS satellite and data transmitted from the reference station. An anomaly due to the move of the reference station is determined by comparing first traveling information calculated from a history of this own-vehicle position and second traveling information calculated from a traveling state of the own vehicle, that has been detected using a vehicle speed sensor and/or the like (paragraphs [0018] and [0026] in the specification of Patent Literature 1, FIG. 1, and the like).

### CITATION LIST

### Patent Literature

Patent Literature 1: Japanese Patent Application Laid-open No. 2006-32275

### DISCLOSURE OF INVENTION

### Technical Problem

For example, in the method described in Patent Literature 1, since information of the mobile station side is necessary for detecting a move of the fixed station, processing may become complicated. In addition, it is difficult to determine the move unless communication with the mobile station is possible. Moreover, although it is possible to provide a dedicated sensor and/or the like for detecting the move of the fixed station, this may lead to an increase of an apparatus size and an increase in costs. Therefore, there is a demand for a technology that enables a state change of a position of the fixed station and/or the like to be detected with a simple configuration and enables unstable positioning to be avoided.

In view of the circumstances as described above, the present technology aims at providing an information processing method, a fixed station, and a program that are capable of detecting a state change of a fixed station with a simple configuration, and avoiding unstable positioning.

### Solution to Problem

To attain the object described above, an information processing method according to an embodiment of the present technology is an information processing method executed by a computer system, and includes detecting a state change of a fixed station which outputs correction data used in GNSS positioning on the basis of GNSS information received by the fixed station. When the state change of the fixed station is detected, at least one of notification processing for notifying of an occurrence of the state change of the fixed station or stop processing for stopping the output of the correction data is executed.

In this information processing method, the state change of the fixed station is detected using the GNSS information received by the fixed station. Further, when the state change of the fixed station has occurred, the processing of notifying of the occurrence of the state change of the fixed station or the processing of stopping the output of the correction data is executed. Accordingly, it becomes possible to detect the state change of the fixed station with a simple configuration, and avoid unstable positioning.

In processing of detecting the state change of the fixed station, at least one of a move of the fixed station or a fall of the fixed station may be detected.

In processing of detecting the state change of the fixed station, the state change of the fixed station may be detected on the basis of an evaluation parameter including at least one of a position of the fixed station, a speed of the fixed station, an acceleration of the fixed station, an angular speed of the fixed station, or positional accuracy of the fixed station, that has been calculated from the GNSS information received by the fixed station.

In the processing of detecting the state change of the fixed station, presence or absence of the state change of the fixed station may be determined by threshold value determination with respect to the evaluation parameter.

The evaluation parameter may include the speed of the fixed station. In this case, in the threshold value determination, it may be determined that the state change of the fixed station has occurred when the speed of the fixed station exceeds a first threshold value.

The evaluation parameter may include the position of the fixed station. In this case, in the threshold value determination, it may be determined that the state change of the fixed station has occurred when a deviation between a position set for the fixed station and a position of the fixed station calculated as the evaluation parameter exceeds a predetermined threshold range.

In the processing of detecting the state change of the fixed station, a threshold value used for the threshold value determination may be varied in accordance with a reception environment of the GNSS information in the fixed station.

In the processing of detecting the state change of the fixed station, presence or absence of the state change of the fixed station may be determined by a learning model that uses the evaluation parameter as an input.

The information processing method may further include acquiring information indicating whether or not the detection of the state change of the fixed station is an error. In this case, when the detection of the state change of the fixed station is an error, the learning model may be caused to learn that the detection of the state change of the fixed station is an error.

The information processing method may further include acquiring information that designates an operation mode related to an operation of the fixed station. In this case, processing of detecting the state change of the fixed station may be executed in accordance with the designated operation mode.

The operation mode may include a mode of outputting the correction data and a mode of not outputting the correction data. In this case, the processing of detecting the state change of the fixed station may be executed when the mode of outputting the correction data is designated, and the processing of detecting the state change of the fixed station does not need to be executed when the mode of not outputting the correction data is designated.

The stop processing may be processing of designating the mode of not outputting the correction data. In this case, when the stop processing is executed, the output of the correction data may be stopped until the mode of outputting the correction data is designated.

The operation mode may include a mode of executing the processing of detecting the state change of the fixed station and a mode of not executing the processing of detecting the state change of the fixed station.

The operation mode may include a mode of constantly executing the processing of detecting the state change of the fixed station.

Processing of detecting the state change of the fixed station may be executed when positional accuracy of the fixed station is lower than a second threshold value.

The notification processing may include notifying of the occurrence of the state change of the fixed station using at least one of sound, vibration, light emission, or a graphical user interface.

The correction data may be used in positioning of a mobile station mounted on a drone. In this case, the notification processing may include selecting a method of notifying of the occurrence of the state change of the fixed station in accordance with an operation status of the drone.

The information processing method may further include comparing input coordinates which are positional coordinates of the fixed station input by a user and observational coordinates which are positional coordinates of the fixed station calculated from the GNSS information received by the fixed station, to detect an error in the input coordinates. In this case, processing of detecting the state change of the fixed station does not need to be executed when there is an error in the input coordinates.

A fixed station according to an embodiment of the present technology is a fixed station which outputs correction data used in GNSS positioning, and includes an antenna, a reception unit, a change detection unit, and an operation control unit.

The reception unit receives GNSS information via the antenna.

The change detection unit detects a state change of the fixed station on the basis of the GNSS information.

The operation control unit executes, when the state change of the fixed station is detected, at least one of notification processing for notifying of an occurrence of the state change of the fixed station or stop processing for stopping the output of the correction data.

A program according to an embodiment of the present technology is a program for causing a computer system to execute the following steps.

A step of detecting a state change of a fixed station which outputs correction data used in GNSS positioning on the basis of GNSS information received by the fixed station.

A step of executing, when the state change of the fixed station is detected, at least one of notification processing for notifying of an occurrence of the state change of the fixed station or stop processing for stopping the output of the correction data.

### BRIEF DESCRIPTION OF DRAWINGS

FIG. 1 A schematic diagram showing a positioning system according to a first embodiment.

FIG. 2 A block diagram showing a configuration example of the positioning system.

FIG. 3 Schematic diagram for explaining a move and fall of a fixed station.

FIG. 4 Schematic diagram each showing a configuration example of the positioning system.

FIG. 5 A flowchart showing an example of an operation of the positioning system.

FIG. 6 A graph for explaining anomaly detection based on a speed of the fixed station.

FIG. 7 A schematic diagram for explaining anomaly detection based on a position of the fixed station.

FIG. 8 An example of a GUI for switching a moves and falls detection function between ON and OFF.

FIG. 9 Schematic diagrams each showing an example of notification means for notifying of a move or fall of the fixed station.

FIG. 10 Examples of a light emission pattern for notifying of the move or fall of the fixed station.

FIG. 11 Examples of an error display for notifying of the move or fall of the fixed station.

FIG. 12 A block diagram showing a functional configuration example of a positioning system according to a second embodiment.

FIG. 13 A flowchart showing an example of an operation of the positioning system according to the second embodiment.

FIG. 14 A block diagram showing a functional configuration example of a positioning system according to a third embodiment.

### MODES FOR CARRYING OUT THE INVENTION Hereinafter embodiments according to the present disclosure will be described with reference to the drawings.

### First Embodiment

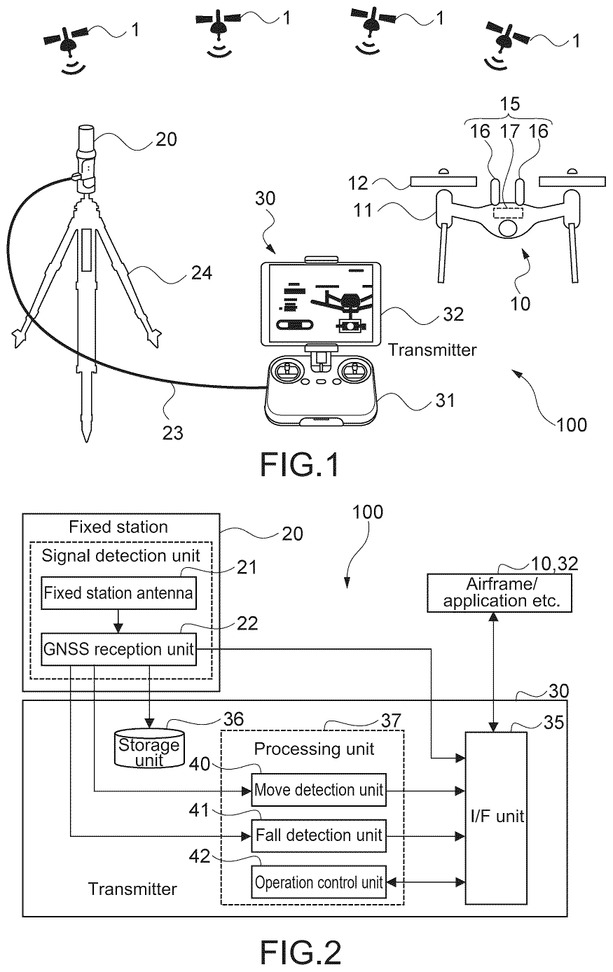

FIG. 1 is a schematic diagram showing a positioning system according to a first embodiment. FIG. 2 is a block diagram showing a configuration example of a positioning system 100. The positioning system 100 is a system that uses a satellite-side system (GNSS) to measure positional coordinates of a positioning target by a real-time kinematic (RTK) method. In the example shown in FIG. 1, the positioning target is an unmanned aerial device (drone 10). As shown in FIG. 1, the positioning system 100 includes a mobile station 15 mounted on the drone 10, a fixed station 20 arranged on the ground, and a transmitter 30 that controls the drone 10.

In the positioning that uses GNSS (hereinafter, will be referred to as GNSS positioning), GNSS information transmitted from a plurality of GNSS satellites 1 is received by a receiver (mobile station 15 and/or fixed station 20). The GNSS information includes information necessary for positioning, such as orbit information of each of the GNSS satellites 1 and a transmission time of the GNSS information. Three-dimensional positional coordinates of the receiver are calculated by calculating a distance (pseudo distance) between each of the GNSS satellites 1 and the receiver from these pieces of GNSS information and time information inside the receiver. The GNSS positioning performed by a single receiver is also called stand-alone positioning, and positioning with an accuracy of, for example, about several meters is possible.

In the GNSS positioning by the RTK method, GNSS information is received by each of the fixed station 20 whose accurate positional coordinates are known in advance and the mobile station 15 as the positioning target. In addition, the fixed station 20 outputs correction data requisite for correcting the positioning in the mobile station 15. Based on this correction data, relative positioning of the mobile station 15 is performed while using the fixed station 20 as a reference.

For example, by using error information obtained by the stand-alone positioning in the fixed station 20, it becomes possible to cancel an error in the mobile station 15. Further, by comparing phases of carrier Waves received by the fixed station 20 and the mobile station 15, it becomes possible to perform interferometric positioning using the phase difference. As a result, in the GNSS positioning by the RTK method, positioning accuracy is significantly improved as compared to that of the stand-alone positioning, and an accuracy of, for example, about several centimeters can be realized.

The drone 10 includes an airframe 11 and a plurality of rotor blades 12 provided in the airframe 11. By controlling driving of the rotor blades 12, the drone 10 can perform various operations such as movements in front-rear and left-right directions, ascending and descending operations, and circling operations. It is noted that the drone 10 is an example of the positioning target to which the positioning system 100 is applied. For example, the positioning system 100 can also be used to measure positions of an autonomous driving vehicle, a construction machinery, and the like.

The mobile station 15 is a radio station mounted on the drone 10. The mobile station 15 includes airframe antennas 16 and an interface unit 17. The airframe antennas 16 are antennas for receiving the GNSS information transmitted from the GNSS satellite 1. In FIG. 1, two airframe antennas 16 are attached to the drone 10. This makes it possible to detect an orientation of the airframe 11. It is noted that the number of airframe antennas 16 is not limited, and the number of airframe antennas 16 may be one, for example. Alternatively, three airframe antennas 16 may be provided. In this case, attitudes of roll, pitch, and yaw of the airframe 11 can be detected.

The interface unit 17 is a communication unit that is connected to the airframe antennas 16 and communicates with the airframe 11 and external devices (transmitter 30 and the like). Further, the interface unit 17 performs GNSS positioning of the drone 10 and outputs positional coordinates of the drone 10. In the present embodiment, the interface unit 17 receives correction data output from the fixed station 20 and performs the GNSS positioning by the RTK method based on the data. It is noted that when correction data is not received, stand-alone positioning can be performed.

The fixed station 20 is a radio station installed on the ground, and outputs correction data to be used for the GNSS positioning. In the present embodiment, the fixed station 20 is configured as a portable device. In the example shown in FIG. 1, a main body of the fixed station 20 is attached to a tripod 24. By configuring the fixed station 20 to be portable in this manner, the fixed station 20 can be arranged near the drone 10, for example, thus enabling the GNSS positioning by the RTK method to be performed at arbitrary locations.

The fixed station 20 is installed at a point where accurate positional coordinates have been measured in advance, for example. Hereinafter, the coordinates set as the accurate positional coordinates of the fixed station 20 may be referred to as setting coordinates. The setting coordinates may be known coordinates, or may be coordinates that have been newly measured. For example, the fixed station 20 is installed right above a reference point where the positional coordinates (latitude, longitude, and altitude) have been measured in advance. In this case, the setting coordinates are coordinate values input by a user. Alternatively, the setting coordinates may be coordinate values that have been measured using GNSS information received by the fixed station 20. In this case, for example, averages of the coordinate values that have been measured after the installation of the fixed station 20, and/or the like are used as the setting coordinates of the fixed station 20.

As shown in FIG. 2, the fixed station 20 includes a fixed station antenna 21 and a GNSS reception unit 22. The fixed station antenna 21 and the GNSS reception unit 22 constitute a signal detection unit of the fixed station 20. The fixed station antenna 21 is an antenna that receives GNSS information transmitted from the GNSS satellite 1. For example, the fixed station antenna 21 is provided on an upper side of the main body of the fixed station 20, and a lower side of the main body is connected to the tripod.

The GNSS reception unit 22 is a reception unit connected to the fixed station antenna 21. The GNSS reception unit 22 is configured to enable the stand-alone positioning of the fixed station 20 to be performed based on the GNSS information received by the fixed station antenna 21. In this case, for example, the positional coordinates of the fixed station 20 are calculated at a predetermined cycle. Hereinafter, the positional coordinates of the fixed station 20 calculated at the predetermined cycle may be referred to as observational coordinates. It is noted that the observational coordinates include, for example, an error in the stand-alone positioning and the like, and therefore do not necessarily completely match with the setting coordinates described above. In the present embodiment, the GNSS reception unit 22 corresponds to a reception unit that receives GNSS information via an antenna.

Further, the GNSS reception unit 22 calculates a speed, an acceleration, an angular speed, positional accuracy, and the like of the fixed station 20 from the position (observational coordinates) of the fixed station 20. It can be said that these pieces of information are secondary information obtained by positioning an observation position. It is noted that when the fixed station 20 is not moving, the speed, acceleration, and angular speed of the fixed station 20 are substantially zero. These parameters calculated from the GNSS information received by the fixed station 20 (fixed station antenna 21) are output to the transmitter 30 to be used in processing of detecting a move or fall of the fixed station 20, which will be described later.

Furthermore, the GNSS reception unit 22 generates correction data for performing the positioning by the RTK method based on the GNSS information received by the fixed station antenna 21. The correction data is generated according to, for example, an RTCM (Radio Technical Commission For Maritime Services) format. The correction data includes, for example, phase information of carrier waves received by the fixed station 20 (fixed station antenna 21) and information on a pseudo distance, setting coordinates of the fixed station 20, and the like. The correction data may also include PVT information including a position (observational coordinates), speed, and time of the fixed station, and/or the like. The correction data is output to the transmitter 30 to be used for positioning of the drone 10 (mobile station 15).

The transmitter 30 is a controller used by the user to control the drone 10. The transmitter 30 shown in FIG. 1 includes a transmitter main body 31 and a display unit 32. The transmitter main body 31 is provided with an operation stick for operating the drone 10, various switches, signal lamps, and the like. The transmitter main body 31 is also configured to be capable of communicating with the fixed station 20 and the drone 10 (mobile station 15).

The display unit 32 is a device that displays a GUI (Graphical User Interface) such as a control screen or a setting screen of the drone 10, and is used by being attached to a fixed portion provided in the transmitter main body 31. As the display unit 32, for example, a terminal device such as a smartphone or a tablet terminal is used. In this case, an application program for controlling the drone 10 may be installed in the mobile terminal. It is noted that a dedicated display device or the like may be used as the display unit 32, or the display unit 32 may be formed integrally with the transmitter main body 31.

As shown in FIG. 2, the transmitter 30 includes an interface unit (I/F unit 35), a storage unit 36, and a processing unit 37. The I/F unit 35, the storage unit 36, and the processing unit 37 are provided inside the transmitter main body 31, for example, but some of these may be provided in the terminal device used as the display unit 32. For example, it is also possible to adopt a configuration in which the I/F unit 35 is provided in the transmitter main body 31, and the storage unit 36 and the processing unit 37 are provided in the display unit 32.

The I/F unit 35 is a communication unit provided in the transmitter 30. The I/F unit 35 is configured to be capable of communicating with the drone 10 (airframe 11), a device that executes the application program for controlling the drone 10, and the like. As the I/F unit 35, for example, a wireless communication module such as WiFi or Bluetooth®, a wired communication module capable of performing communication via a wired connection, such as USB, or the like is used.

For example, correction data output from the GNSS reception unit 22, signals generated by respective functional blocks in the processing unit 37, and the like are output to the drone 10, the external device, and the like via the I/F unit 35. Moreover, data output from the drone 10 (position data, video data, and the like), control commands generated by the application program, and the like are read by the processing unit 37 via the I/F unit 35.

The storage unit 36 is a non-volatile storage device. For example, a recording medium that uses a solid-state element such as an SSD or a magnetic recording medium such as an HDD is used as the storage unit 36. In addition, a type of recording medium to be used as the storage unit 36, and the like are not limited, and any non-transitory recording medium for recording data may be used, for example.

The storage unit 36 stores a control program for operating the positioning system 100. The storage unit 36 also stores information on an observation position output from the GNSS reception unit 22 of the fixed station 20, and the like and information on the setting coordinates set when installing the fixed station 20, and the like. Other information to be stored in the storage unit 36 is not limited.

The processing unit 37 is an arithmetic unit that controls operations of the positioning system 100. The processing unit 37 has, for example, a hardware configuration requisite for a computer, such as a CPU and a memory (RAM, ROM). The CPU loads the control program stored in the storage unit 36 into the RAM and executes the control program, to thus execute various types of processing. The processing unit 37 corresponds to an information processing apparatus according to the present embodiment.

The processing unit 37 may be implemented by a PLD (Programmable Logic Device) such as an FPGA (Field Programmable Gate Array) or other devices such as an ASIC (Application Specific Integrated Circuit).

In the present embodiment, the CPU of the processing unit 37 executes the program (control program) according to the present embodiment to realize, as the functional blocks, a move detection unit 40, a fall detection unit 41, and an operation control unit 42. Further, these functional blocks execute an information processing method according to the present embodiment. It is noted that dedicated hardware such as an IC (integrated circuit) may be used as appropriate for realizing the functional blocks.

In the positioning system 100, the processing unit 37 detects a state change of the fixed station 20. In the present disclosure, the state of the fixed station 20 includes a state of at least one of a position or attitude of the fixed station 20. Therefore, detecting a state change of the fixed station 20 means detecting at least one of a change in the position of the fixed station 20 or a change in the attitude of the fixed station 20.

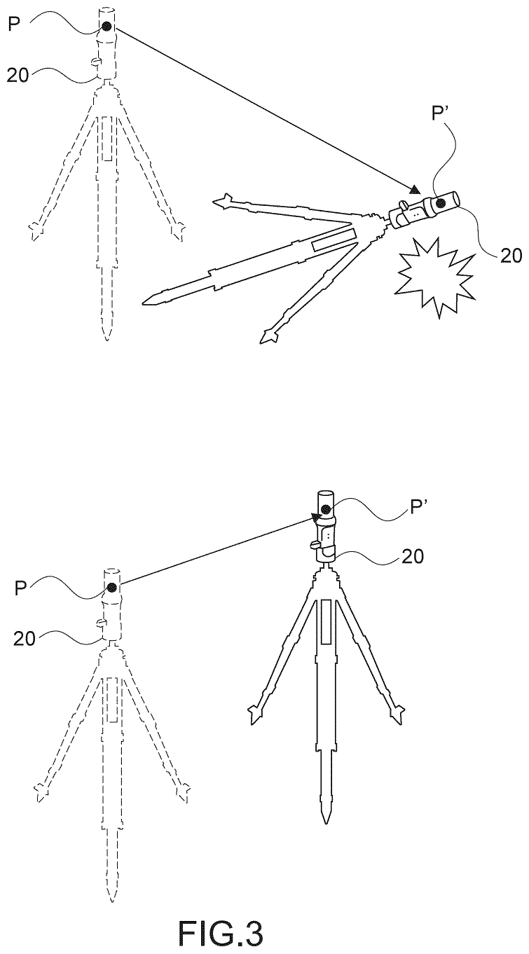

Here, a case where the position or attitude of the fixed station 20 changes will be described. As described above, in the GNSS positioning by the RTK method, the positioning of the mobile station 15 is corrected based on the position (setting coordinates) of the fixed station 20. Therefore, for example, if the actual position of the fixed station 20 is deviated from the setting coordinates, positioning accuracy is lowered, and stable positioning becomes difficult. In addition, if the attitude of the fixed station 20 (fixed station antenna 21) changes, reception performance with respect to the GNSS information may change (see FIG. 3A). Therefore, the positioning accuracy may be lowered also by the deviation of the attitude of the fixed station 20 from an appropriate attitude. In this manner, an anomaly of the fixed station 20 occurs when the position of the fixed station 20 moves from the setting coordinates or the attitude of the fixed station 20 deviates from the appropriate attitude. Here, an anomaly of the fixed station 20 is a state where the state (position or attitude) of the fixed station 20 changes beyond a certain level to cause a problem in positioning.

In this regard, in the present embodiment, a move or fall of the fixed station 20 is detected as the state change of the fixed station 20. By detecting the move or fall of the fixed station 20, it becomes possible to detect an anomaly of the fixed station 20 due to a change in the position or attitude of the fixed station 20. In the present embodiment, the processing of detecting a move or fall of the fixed station 20 is processing of detecting an anomaly of the fixed station 20, and is an example of processing of detecting a state change of the fixed station. It is noted that hereinafter, the move or fall of the fixed station 20 may be simply referred to as an anomaly of the fixed station 20.

FIG. 3 are schematic diagrams for explaining the move and fall of the fixed station 20. In FIG. 3A, a position P (setting position) of the fixed station 20 before the fixed station 20 falls over and a position P′ of the fixed station 20 after the fixed station 20 falls over are schematically illustrated by black circles. Similarly, in FIG. 3B, the position P (setting position) of the fixed station 20 before the fixed station 20 moves and the position P′ of the fixed station 20 after the fixed station 20 moves are schematically illustrated by black circles.

In the example shown in FIG. 3A, the fixed station 20 fixed to the tripod 24 falls over, and thus the position of the fixed station 20 is changed. In this case, the position P′ of the fixed station 20 after the fall may change significantly in a planar direction and a height direction from the position P before the fall. In addition, since a directivity of an antenna is usually designed such that a radiation pattern is oriented toward a zenith direction, the fall also affects the reception performance of the reception unit. Accordingly, there is a possibility that a deviation of several tens of centimeters to several meters will be caused to thus lower the positioning accuracy.

Further, in the example shown in FIG. 3B, the fixed station 20 fixed to the tripod 24 is moved from the setting position. In this case, the position P′ of the fixed station 20 after the move may change significantly mainly in the planar direction from the position P before the move. Moreover, for example, in a case where an adjustment pole of the tripod 24 in the height direction has become loose, and/or the like, the fixed station 20 may also move in the height direction. Even when the fixed station 20 is moved, depending on an amount of the move, it may not be possible to control the drone 10 with required accuracy.

For example, the fixed station 20 may fall or move when an operator bumps into the fixed station 20, when a gust of wind blows, and/or the like. In the processing unit 37, at least one of the move of the fixed station 20 or the fall of the fixed station 20 is detected by the processing of detecting an anomaly. In the present embodiment, both the move and fall of the fixed station 20 can be detected. It is noted that it is not always necessary to individually detect the move and fall of the fixed station 20. For example, a state where the position, attitude, or the like of the fixed station 20 changes and the positioning accuracy is lowered may be detected as an anomalous state of the fixed station 20 without making a distinction of the state between the move, fall, and the like.

Returning to FIG. 2, the move detection unit 40 and the fall detection unit 41 detect a move or fall of the fixed station 20 based on the GNSS information received by the fixed station 20. Specifically, the move detection unit 40 detects a move of the fixed station 20 based on evaluation parameters output from the GNSS reception unit 22. Further, the fall detection unit 41 detects a fall of the fixed station 20 based on the evaluation parameters output from the GNSS reception unit 22. In the present embodiment, the move detection unit 40 and the fall detection unit constitute a change detection unit that detects a state change of the fixed station based on the GNSS information received by the fixed station.

As described above, the GNSS reception unit 22 of the fixed station 20 calculates the position (observational coordinates), speed, acceleration, angular speed, positional accuracy, and the like of the fixed station 20 from the GNSS information. The move detection unit 40 and the fall detection unit 41 detect a move and fall of the fixed station 20 using these pieces of information as the evaluation parameters. It is noted that the move detection unit 40 and the fall detection unit 41 may read only the position (observational coordinates) of the fixed station 20 and calculate other evaluation parameters as appropriate. Alternatively, the move detection unit 40 and the fall detection unit 41 may read the GNSS information received by the fixed station 20 as it is and calculate necessary evaluation parameters.

In this manner, in the present embodiment, a move or fall of the fixed station 20 is detected using, as the evaluation parameters, secondary values (speed, acceleration, angular speed, positional accuracy information, and the like) obtained from the position of the fixed station 20 in addition to the position (observational coordinates) of the fixed station 20 obtained from the GNSS information received by the fixed station 20. This makes it possible to detect a move or fall of the fixed station 20 with a high probability, without adding an attitude detection device such as an inertial measurement unit (IMU), for example.

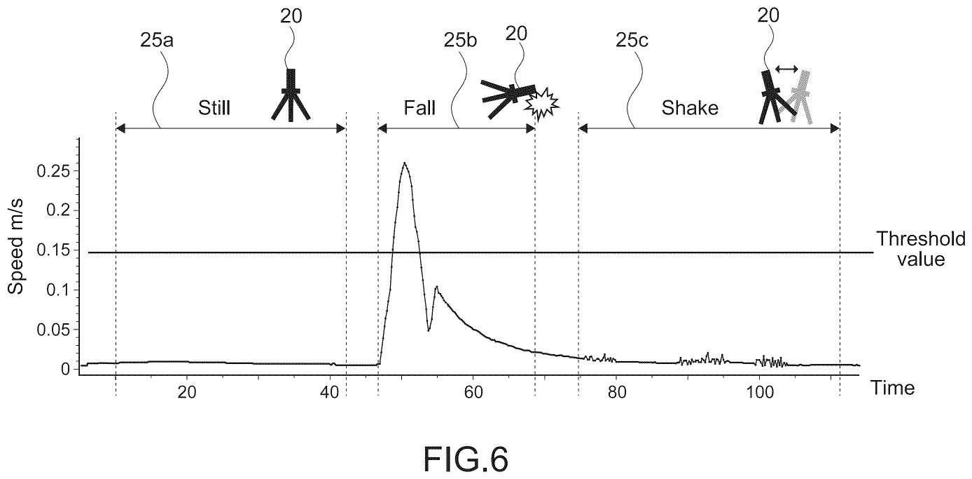

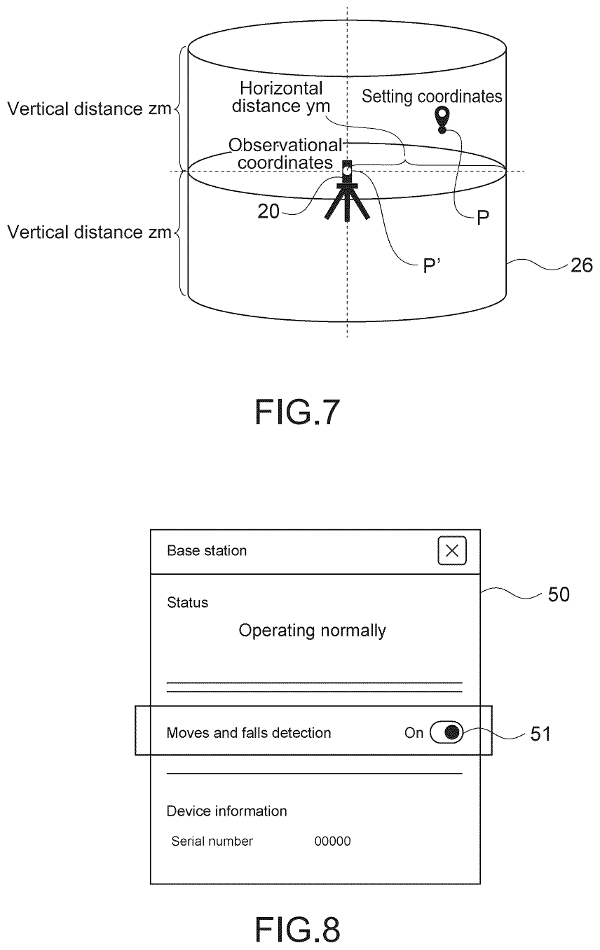

For example, threshold value determination is used in the detection of a move or fall that uses the evaluation parameters. Alternatively, a move or fall may be detected by using a learning model that has learned the evaluation parameters using an AI technology and/or the like. A method of detecting a move or fall of the fixed station 20 using the evaluation parameters will be described in detail later with reference to FIGS. 6, 7, and the like.

The operation control unit 42 is a control block that controls the operations of the positioning system 100. For example, the operation control unit 42 executes processing that is performed when a move or fall of the fixed station 20 is detected, determination on whether or not to perform the processing of detecting a move or fall of the fixed station 20 (processing of detecting an anomaly), and the like.

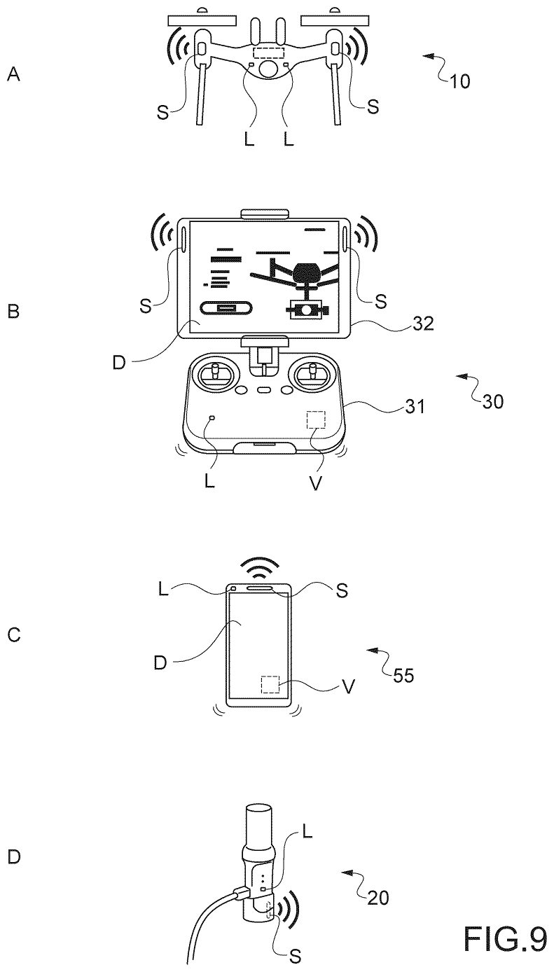

When the move detection unit 40 or the fall detection unit 41 detects a move or fall of the fixed station 20, the operation control unit 42 executes notification processing for notifying the user of an occurrence of the move or fall of the fixed station 20. Specifically, a command to notify of an occurrence of the move or fall, and/or the like are output to various notification means (see FIG. 9 and the like) provided in the positioning system 100. Further, when a move or fall of the fixed station 20 is detected, the operation control unit 42 executes stop processing for stopping the output of correction data. Specifically, a command to stop the output of correction data, and/or the like are output to the GNSS reception unit 22 of the fixed station 20. In this manner, when a move or fall of the fixed station 20 is detected, the operation control unit 42 executes the notification processing, the stop processing, and the like by outputting commands to the notification means and/or the GNSS reception unit 22.

Further, the operation control unit 42 acquires information that designates an operation mode related to the operation of the fixed station 20, and executes the processing of detecting an anomaly in accordance with the designated operation mode. In the positioning system 100, various operation modes related to the operation of the fixed station 20 are provided. Each of the operation modes is selected by the user via, for example, the GUI and/or the like. Alternatively, the operation mode may be automatically switched according to the processing of the positioning system 100 (control program).

The operation modes include a mode of outputting correction data and a mode of not outputting correction data. Of these, the mode of outputting correction data is, for example, a mode of performing positioning using the RTK method, a mode of performing an output test of correction data, or the like. The operation modes also include a mode of executing the processing of detecting an anomaly and a mode of not executing the processing of detecting an anomaly. Various other modes that designate the type and/or content of the processing of detecting an anomaly may also be provided. The operation control unit 42 controls the operations of the move detection unit 40 and the fall detection unit 41 according to the operation mode designated by the user or the system out of these modes.

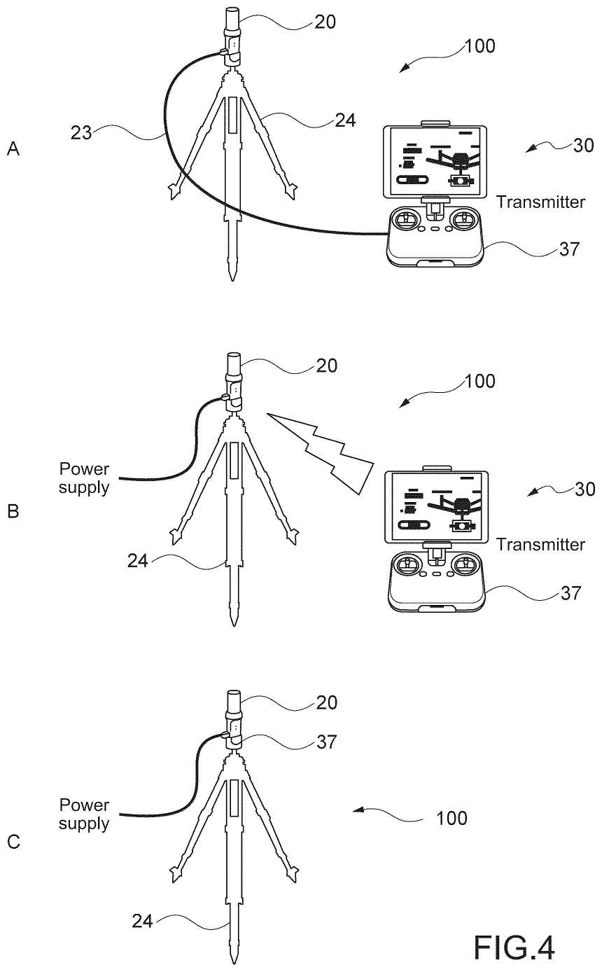

FIG. 4 are schematic diagrams each showing a configuration example of the positioning system 100. As described above, the present technology is capable of detecting a move or fall of the fixed station 20 without providing a dedicated sensor and/or the like. Therefore, the processing unit 37 that executes the processing of detecting an anomaly can be provided outside the fixed station 20 (here, the transmitter 30) or can be provided integrally with the fixed station 20 itself. This makes it possible to improve flexibility of the configuration and improve portability of the fixed station 20.

In FIG. 4A, the fixed station 20 and the transmitter 30 have a wired connection by a communication cable 23. This configuration is similar to the configuration shown in FIG. 1. For example, a USB cable or the like is used as the communication cable 23. Further, the communication cable 23 may function as a power supply cable. There are no other limitations on the type of communication cable. By the wired connection between the fixed station 20 and the transmitter 30, it is possible to reliably realize, for example, transmission of correction data and control of the fixed station, and improve stability of the positioning system 100.

In FIG. 4B, the fixed station 20 and the transmitter 30 are configured to perform wireless communication. In this case, the fixed station 20 is connected to a predetermined power supply. It is noted that the fixed station 20 may be battery-powered. The type of wireless communication is not limited, and Wi-Fi, Bluetooth®, or the like may be used, for example. By using wireless communication, the transmitter 30 can be moved freely, which reduces a load of the user who operates the transmitter 30.

In FIGS. 4A and 4B, the processing unit 37 that detects a move or fall of the fixed station 20 is provided in the transmitter 30. This makes it possible to detect an anomaly regardless of the type of the fixed station 20, for example.

Furthermore, the fixed station 20 does not need to perform the processing of detecting an anomaly, and the like. This makes it possible to configure the fixed station 20 at low costs, for example.

In FIG. 4C, the processing unit 37 that detects a move or fall of the fixed station 20 is provided in the fixed station 20. In other words, the processing unit 37 may be formed integrally with the fixed station 20 itself. In this case, for example, it becomes possible for the fixed station 20 alone to detect an anomaly, regardless of the configuration of the transmitter 30. It is noted that when an anomaly is detected in the fixed station 20, information indicating an occurrence of the anomaly, or the like is output to the transmitter 30. In this manner, by providing the processing unit 37 in the fixed station 20 itself, it is possible to easily introduce the anomaly detection function of the fixed station 20 into various systems that use the drone 10.

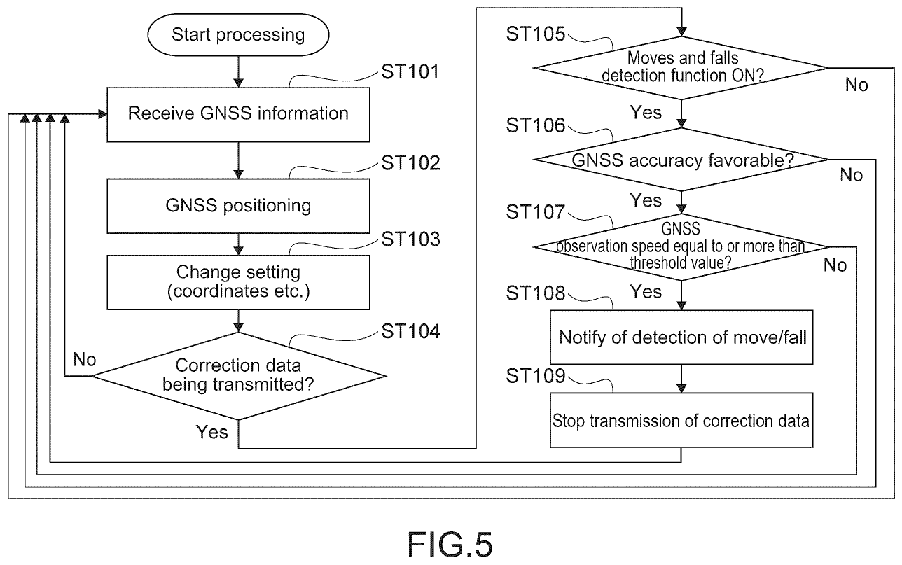

FIG. 5 is a flowchart showing an example of the operation of the positioning system 100. The processing shown in FIG. 5 is, for example, processing that is repeatedly executed during the operation of the positioning system 100. Here, the operation on the fixed station 20 side will mainly be described.

First, the fixed station 20 receives the GNSS information transmitted from the GNSS satellite 1 (Step 101). Specifically, the GNSS information received by the fixed station antenna 21 is read by the GNSS reception unit 22.

Next, the fixed station 20 executes GNSS positioning of itself (Step 102). Specifically, the GNSS reception unit 22 calculates the position (observational coordinates) of the fixed station 20 based on the GNSS information received in Step 101.

Further, when the mode of outputting correction data is selected, correction data is generated by the GNSS reception unit 22, and the correction data is output to the drone 10 (mobile station 15) via the I/F unit 35 of the transmitter 30. In this case, the mobile station 15 performs the GNSS positioning by the RTK method using the correction data from the fixed station 20. It is noted that when the mode of not outputting correction data is selected, no correction data is output, and the mobile station 15 performs stand-alone positioning.

Along with the GNSS positioning of the fixed station 20, the evaluation parameters such as the speed, acceleration, angular speed, and positional accuracy of the fixed station 20 are calculated. It is noted that the processing of calculating the evaluation parameters may be executed by the GNSS reception unit 22 of the fixed station 20, or may be executed by the processing unit 37.

For example, the speed and/or angular speed of the fixed station 20 are calculated by differentiating a temporal change of the observational coordinates of the fixed station 20. Further, the acceleration of the fixed station 20 is calculated by differentiating a temporal change of the speed of the fixed station 20. The speed, acceleration, and angular speed of the fixed station 20 may be calculated as three-dimensional vectors, or may be calculated as magnitudes (norms) of the three-dimensional vectors. Furthermore, for example, the positional accuracy of the observational coordinates is calculated from a reception state of GNSS information (the number of satellites, a reception intensity of radio waves, and the like).

Next, the operation control unit 42 accepts a setting change (Step 103). Here, a content of the setting change made by the user on a setting screen or the like is read. For example, when the setting coordinates of the fixed station 20 are changed, coordinate values that have been newly set are read. Further, when the various operation modes are changed, information for designating the operation mode, or the like is read.

Next, the operation control unit 42 determines whether or not correction data is being transmitted (Step 104). This is processing of determining which of the mode of outputting correction data and the mode of not outputting correction data is being selected. When the mode of outputting correction data is selected, it is determined that the correction data is being transmitted. Conversely, when the mode of not outputting correction data is selected, it is determined that the correction data is not being transmitted.

For example, when it is determined that the correction data is not being transmitted (No in Step 104), the processing returns to Step 101, and a value of GNSS information reception is referenced. It is noted that the GNSS information reception itself is performed constantly. In this case, since the correction data is not being transmitted, correction data is not output in Step 102 until the mode is changed. Also, while the mode is the mode of not outputting correction data, the processing from Step 101 to Step 104 is repeated, and the processing of detecting an anomaly of the fixed station 20 is not executed.

When it is determined that the correction data is being transmitted (Yes in Step 104), the processing of Step 105 and subsequent steps is executed. In this case, the processing of detecting an anomaly of the fixed station 20 (here, Step 107) is executed when a predetermined condition is satisfied.

For example, at a stage before the correction data is transmitted, that is, at a stage before positioning of the drone 10 by the RTK method is started, the user may intentionally move the fixed station 20. When the detection of an anomaly is performed when the correction data is not output, it may actually hinder a task of the user. On the other hand, when transmitting correction data to perform positioning of the drone 10 by the RTK method or when performing a correction data reception test and/or the like, it is necessary to detect a move or fall of the fixed station 20.

In this regard, in the present embodiment, the processing of detecting an anomaly is executed when the mode of outputting correction data is designated, and the processing of detecting an anomaly is not executed when the mode of not outputting correction data is designated. Accordingly, the task of the user before transmission of correction data is not inhibited, and it becomes possible to realize a user-friendly system.

In Step 105, the operation control unit 42 determines whether or not a moves and falls detection function of the fixed station 20 is ON. This is processing of determining which of the mode of executing the processing of detecting an anomaly and the mode of not executing the processing of detecting an anomaly is being selected. ON and OFF of the moves and falls detection function are selected by the user via, for example, a predetermined GUI (see FIG. 8 and the like). When the moves and falls detection function is OFF (No in Step 105), the processing returns to Step 101, and the value of the GNSS information reception of the fixed station 20 is referenced. In this case, the processing of detecting an anomaly is not executed.

On the other hand, when the moves and falls detection function is ON (Yes in Step 105), the operation control unit 42 determines whether or not GNSS accuracy is favorable (Step 106). Here, the GNSS accuracy is the positional accuracy of the fixed station 20 in the GNSS positioning. For example, the determination on whether or not the GNSS accuracy is favorable is processing of determining whether or not the positional accuracy of the fixed station 20 is higher than a predetermined threshold value. In the present embodiment, the predetermined threshold value for determining the positional accuracy of the fixed station 20 corresponds to a second threshold value.

It is noted that the positional accuracy of the fixed station 20 is calculated as an error of the observational coordinates of the fixed station 20 that have been calculated by the GNSS positioning, for example. In this case, the determination on whether or not the positional accuracy of the fixed station 20 is higher than the predetermined threshold value becomes determination on whether or not the error of the observational coordinates is smaller than a value set as the threshold value.

For example, in a poor reception environment such as a case where the number of GNSS satellites 1 from which information can be received is small or a case where a radio wave reception intensity is low, the positional accuracy of the GNSS positioning is lowered. As a result, the accuracy of the evaluation parameters for detecting a move or fall of the fixed station 20 decreases, thus increasing the possibility of erroneous detection. Therefore, when the GNSS accuracy is unfavorable (No in Step 106), the processing returns to Step 101, and the GNSS positioning of the fixed station 20 is executed again. In this case, the processing of detecting an anomaly is not executed.

In this manner, in the present embodiment, when the positional accuracy of the fixed station 20 is lower than the predetermined threshold value, the processing of detecting an anomaly is not executed. This makes it possible to avoid erroneous detection of a move or fall of the fixed station 20 in the case of a poor reception environment. As a result, it becomes possible to avoid a situation where, for example, an erroneous message is presented to the user so as to inhibit the task of the user.

It is noted that the descriptions have been given on the example in which the processing of detecting an anomaly is not executed when the GNSS accuracy (reception environment) is unfavorable in Step 106. However, the present technology is not limited to this, and it is also possible to adopt a configuration in which the processing of detecting an anomaly is not executed under a condition where it is considered that the detection of a move or fall of the fixed station 20 will not operate normally for some reason other than the reception environment.

On the other hand, when the positional accuracy of the fixed station 20 is higher than the predetermined threshold value and the GNSS accuracy is favorable (Yes in Step 106), the processing of detecting an anomaly of the fixed station 20 is executed (Step 107). Here, a move or fall of the fixed station 20, which is a state change of the fixed station 20, is detected based on the GNSS information received by the fixed station 20. This makes it possible to detect a move or fall of the fixed station 20 with a simple configuration without using a sensor such as an IMU.

In the present embodiment, the move or fall of the fixed station 20 is detected based on the evaluation parameters including at least one of the position (observational coordinates) of the fixed station 20, the speed of the fixed station 20, the acceleration of the fixed station 20, the angular speed of the fixed station 20, or the positional accuracy of the fixed station 20, that has been calculated from the GNSS information received by the fixed station 20. It can be said that all of these evaluation parameters are GNSS observation data that can be calculated from the GNSS information. In addition, each of the evaluation parameters exhibits a characteristic behavior along with the move or fall of the fixed station 20, for example. By evaluating these behaviors individually or in combination, it becomes possible to accurately detect a move or fall of the fixed station 20.

First, the processing of detecting an anomaly when the evaluation parameter exceeds a specific threshold value will be described. In this processing, presence or absence of an anomaly is determined by threshold value determination with respect to the evaluation parameter. By using the threshold value determination, it is possible to reduce a processing load requisite for detecting an anomaly, for example. It is noted that FIG. 5 shows the threshold value determination on the speed of the fixed station 20 (a GNSS observation speed calculated from the observational coordinates of the fixed station 20) as an example of the threshold value determination.

FIG. 6 is a graph for explaining anomaly detection based on the speed of the fixed station 20. The graph shown in FIG. 6 shows a temporal change of the speed (GNSS observation speed) of the fixed station 20 that has been calculated from the GNSS information received by the fixed station 20. Here, the magnitude (speed norm) of the speed vector of the fixed station 20 is plotted. FIG. 6 also includes, in the stated order, a period 25a in which the fixed station 20 is still, a period 25b in which the fixed station 20 has fallen over, and a period 25c in which the fixed station 20 is shaken. The speed of the fixed station 20 is monitored at a cycle of, for example, about 5 Hz.

For example, in the period 25a in which the fixed station 20 is still, the position of the fixed station 20 does not change. Therefore, the observational coordinates obtained by the GNSS positioning also hardly change, so the speed of the fixed station 20 is substantially zero. On the other hand, in the period 25b in which the fixed station 20 has fallen over, a temporal change in which the speed of the fixed station 20 increases rapidly and after passing a peak, decreases rapidly can be seen. It is noted that there may also be a case where, by the fixed station 20 rolling at the time of the fall, the speed increases again after passing the first peak as shown in the graph, and the like. Further, in the period 25c in which the fixed station 20 is shaken, minute peaks of the speed are detected. It is noted that the change of the speed due to the shake is sufficiently smaller than that of the case where the fixed station 20 has fallen over, and the like.

In this manner, the speed at the time of the fall largely differs from the speed in the still state and the speed at the time of the shake. Therefore, for example, by setting the threshold value so as to detect only the peak of the speed at the time of the fall, the speed of the fixed station 20 exceeds the threshold value only at the time of the fall, and it becomes possible to detect an anomaly of the fixed station 20. Therefore, when the speed of the fixed station 20 is used as the evaluation parameter, it is determined in the threshold value determination that an anomaly has occurred when the speed of the fixed station 20 exceeds a predetermined threshold value. In the present embodiment, the predetermined threshold value used for determining the speed of the fixed station 20 corresponds to a first threshold value.

The threshold value for determining the speed is set such that, for example, a waveform of the speed when the fixed station 20 falls over is measured a plurality of times so as to enable the first peak that appears to be detected independently. In the example shown in FIG. 6, the threshold value for determining the speed is set to about 0.15 m/s, but the threshold value is not limited to this. For example, the peak value of the speed when the fixed station 20 falls over may differ depending on the height at which the fixed station 20 is installed. Therefore, the threshold value may be set as appropriate in accordance with the configuration of the fixed station 20 used.

Furthermore, it is also possible to determine whether or not the fixed station 20 has moved by determining the speed of the fixed station 20. For example, the threshold value for determining the speed is set such that the speed at which a person moves while carrying the fixed station 20 can be detected. In addition, for example, it may be determined that the fixed station 20 has moved when a period during which the speed of the fixed station 20 exceeds the threshold value continues for a certain period of time.

In addition, when the fixed station 20 shakes and returns to its original position, for example, even if the position does not appear to have changed by the determination based on the observational coordinates alone, the position may have changed in actuality. By using the speed of the fixed station 20 and setting the threshold value as appropriate, it is also possible to detect such a position change that returns to its original position in one cycle.

In FIG. 6, the detection of an anomaly based on the magnitude of the speed has been described, but it is also possible to determine the speed of the fixed station 20 separately for the horizontal speed and the vertical speed. This makes it possible to set a threshold value for detecting a fall for the vertical speed, and set a threshold value for detecting a move for the horizontal speed, for example.

FIG. 7 is a schematic diagram for explaining the detection of an anomaly based on the position of the fixed station 20. Here, the threshold value determination on the position (observational coordinates) of the fixed station 20 calculated from GNSS information will be described. FIG. 7 schematically shows a threshold range 26 for determining the position of the fixed station 20, the setting coordinates P of the fixed station 20, and the observational coordinates P′ of the fixed station 20.

When the position of the fixed station 20 is used as the evaluation parameter, it is determined in the threshold value determination that an anomaly has occurred when a deviation between the position set for the fixed station 20 (setting coordinates P) and the position of the fixed station 20 calculated as the evaluation parameter (observational coordinates P′) exceeds the predetermined threshold range 26.

The predetermined threshold range 26 is set, for example, as a range centered on the observational coordinates P′. In this case, when the setting coordinates P are included in the threshold range 26, it is determined that an anomaly of the fixed station 20 has not occurred. On the other hand, when the setting coordinates P are not included in the threshold range 26, it is determined that an anomaly of the fixed station 20 has occurred. For example, since the setting coordinates P are included in the threshold range 26 in FIG. 7, it is determined that no anomaly has occurred.

In the example shown in FIG. 7, a cylindrical range centered on the observational coordinates P′ is set as the threshold range 26. In this threshold range 26, ranges in the up-down direction of the observational coordinates P′ are set as vertical distances z (m), and ranges in the horizontal direction centered on the observational coordinates P′ are set as horizontal distances y (m). The horizontal distance y is a radius of the cylindrical threshold range 26.

The vertical distance z and the horizontal distance y are set according to, for example, the accuracy of the observational coordinates P′, and/or the like. The vertical distance z is favorably set to 1.5 m or more and 4.5 m or less. This makes it possible to accurately detect a move of the fixed station 20 in the vertical direction due to a fall and/or the like, for example. Further, the horizontal distance y is favorably set to 1 m or more and 3 m or less. This makes it possible to accurately detect a move of the fixed station 20 in the horizontal direction due to a collision or the like, for example.

It is noted that the shape of the threshold range 26 is not limited to the cylindrical shape. For example, a spherical range centered on the observational coordinates P′ may be set as the threshold range 26. Furthermore, the threshold range 26 does not need to be of a three-dimensional shape. For example, a circular plane or the like formed along the horizontal plane centered on the observational coordinates P′ may be set as the threshold range 26. There are no other limitations on the size and shape of the threshold range 26, and the threshold range 26 may be set as appropriate in accordance with the configuration of the fixed station 20 so as to enable a move or fall to be detected, for example.

The descriptions above have been given on the threshold value determination on the speed and position of the fixed station 20 as the evaluation parameters, but it is also possible to detect an anomaly by the threshold value determination on other evaluation parameters such as the acceleration, the angular speed, and the positional accuracy.

When the acceleration of the fixed station 20 is used as the evaluation parameter, it is determined that an anomaly has occurred when the acceleration exceeds a predetermined threshold value. The acceleration of the fixed station 20 can be calculated by, for example, differentiating the speed of the fixed station 20. Therefore, when the speed increases sharply, a high acceleration is detected. The threshold value is set so that such a change in the acceleration can be detected. This makes it possible to easily detect a peak and/or the like in the case where the fixed station 20 has fallen over, for example.

It is also possible to detect a fall of the fixed station 20 by detecting a rise of a vertical component of the acceleration (a speed change in the vertical direction). Further, when the fixed station 20 is moved by the user or the like, a large speed change occurs at the beginning and end of the move. The move of the fixed station 20 may be detected by determining this from the acceleration.

When the angular speed of the fixed station 20 is used as the evaluation parameter, it is determined that an anomaly has occurred when the angular speed exceeds a predetermined threshold value. The angular speed of the fixed station 20 can be calculated from, for example, a change in the orientation of the speed vector of the fixed station 20. For example, when the fixed station 20 makes a rotational motion, the orientation of the speed changes, and a high angular speed is detected. The threshold value is set so that such a change in the angular speed can be detected.

For example, the angular speed may change due to a rotational motion that occurs when the fixed station 20 falls over. By setting the threshold value so as to enable such a change in the angular speed to be detected, it becomes possible to detect a fall of the fixed station 20. Alternatively, a move of the fixed station 20 may be detected by detecting a change in the angular speed in a case where the user moves while carrying the fixed station 20, in a case where the user puts down the fixed station 20, and the like.

Furthermore, the positional accuracy of the fixed station 20 may be used as the evaluation parameter to execute the threshold value determination on the positional accuracy. For example, by a change of the attitude of the fixed station antenna 21 due to a move or fall of the fixed station 20, the reception state of GNSS information may change to change the positional accuracy. By setting the threshold value so that such a change in the positional accuracy can be detected, it is possible to determine an anomaly of the fixed station 20 including moves and falls.

Heretofore, the method of individually executing the threshold value determination for each of the evaluation parameters and determining an anomaly of the fixed station 20 including moves and falls has been described. The threshold value determinations on these evaluation parameters can also be used in combination.

For example, when both the threshold value determination on the speed and the threshold value determination on the position (observational coordinates) have determined an anomaly, it is possible to perform processing of making final determination on the occurrence of the anomaly of the fixed station 20. Alternatively, the final determination on the occurrence of the anomaly of the fixed station 20 may be output when the anomaly is determined for a certain number of parameters or more out of the plurality of evaluation parameters. Further, for example, it is also possible to perform processing of assigning points corresponding to the reliability of the determination and/or the like to the determination results of the evaluation parameters, and determining that an anomaly has occurred when a sum of the points exceeds a certain value.

The method of combining the determinations that use the plurality of evaluation parameters is not limited. For example, a threshold value determination in which characteristics of the evaluation parameters are combined may be performed, for example. As an example, there is processing in which, even in a case where the speed of the fixed station 20 exceeds the threshold value, when the vertical position of the observational coordinates has not changed, it is considered that the possibility of a fall is low and is thus not determined as an anomaly. Any other determination processing may be used in accordance with the characteristics at the time of the fall and/or at the time of the move.

Further, the threshold value used in the threshold value determination may be a fixed value as described above, or may be a value dynamically calculated based on environmental conditions, and the like. When dynamically setting the threshold value, for example, processing of making the threshold value variable in accordance with the value of the GNSS positional accuracy, or the like is conceivable. That is, in the processing of detecting an anomaly, the threshold value used in the threshold value determination is varied in accordance with the reception environment of GNSS information in the fixed station 20.

In this case, for example, as the GNSS positional accuracy becomes lower, the threshold range of the position becomes wider, and the threshold values for the speed, acceleration, angular speed, and the like are set to be higher. This makes it possible to avoid erroneous detection accompanying lowering of the positional accuracy. Conversely, when the positional accuracy of the GNSS is high, the threshold range of the position is set to be narrow, and the threshold values for the speed, acceleration, angular speed, and the like are set to be low. This makes it possible to improve the accuracy in detecting a move or fall of the fixed station 20.

In addition to the threshold value determination, a method that uses a learning model may be used as the processing of detecting an anomaly using the evaluation parameter. That is, in the processing of detecting an anomaly, the presence or absence of an anomaly may be determined by a learning model that uses the evaluation parameter as an input. By using the learning model, it becomes possible to determine an anomaly of the fixed station 20 including moves and falls with high accuracy.

The learning model is a learned model constructed by using a machine learning technique such as deep learning. For example, by having a machine learning model learn patterns of a move, a fall, and the like that have been acquired in the past, a learning model that determines the presence or absence of an anomaly of the fixed station including a move or a fall while using the evaluation parameters as an input is constructed. In this case, some or all of the evaluation parameters described above (position, speed, acceleration, angular speed, positional accuracy, and the like) are used as input data. There are no other limitations on the method of constructing a learning model, the type of input data, and the like.

Returning to FIG. 5, when no anomaly of the fixed station 20 is detected in Step 107 (No in Step 107), the processing returns to Step 101, and the value of the GNSS information reception of the fixed station 20 is referenced. Here, when the speed of the fixed station 20 is smaller than the threshold value, it is determined that no anomaly of the fixed station 20 has occurred assuming that the speed change of the fixed station 20 is small.

On the other hand, when an anomaly of the fixed station 20 is detected in Step 107 (Yes in Step 107), the fact that a move or fall of the fixed station 20 has been detected is notified (Step 108). That is, when an anomaly is detected, notification processing for notifying of an occurrence of the anomaly is executed. Here, when the speed of the fixed station 20 is equal to or more than the threshold value, it is determined that an anomaly of the fixed station 20 including moves and falls has occurred. Then, the operation control unit 42 executes the notification processing to notify of the occurrence of the anomaly of the fixed station 20. Accordingly, it becomes possible for the user to recognize that the anomaly has occurred due to the move or fall of the fixed station 20, and to cope with the anomaly of the fixed station 20. Specific contents of the notification processing will be described later with reference to FIGS. 9 to 11 and the like.

Next, the transmission of correction data is stopped (Step 109). For example, the operation control unit 42 controls the GNSS reception unit 22 to stop the correction data generation processing so that the correction data is no longer output from the fixed station 20. As a result, the transmission of the correction data to the drone 10 (mobile station 15) via the transmitter 30 is stopped. In this manner, when an anomaly is detected, stop processing for stopping the output of correction data is executed. This makes it possible to prevent the positioning by the RTK method from being performed using erroneous correction data, and avoid unstable positioning.

In addition, the stop processing for stopping the output of correction data is also processing of designating the mode of not outputting correction data. Therefore, when the stop processing is executed, the output of correction data is stopped until the mode of outputting correction data is designated.

When the stop processing is executed, the processing returns to Step 101, and the value of the GNSS information reception of the fixed station 20 is referenced. In this case, for example, immediately after the stop processing is executed, the output of correction data is not resumed since a task of eliminating the anomaly of the fixed station 20 is necessary. When the anomaly of the fixed station 20 is eliminated and the user performs an operation to resume the output of correction data (an operation to start the positioning by the RTK method, and/or the like), the output of correction data is resumed in Step 102.

In this manner, at a stage where correction data is output again, the anomaly of the fixed station 20 including moves and falls is eliminated for sure. This makes it possible to reliably avoid unstable positioning. For example, there is a risk that the drone 10 will malfunction by merely detecting an anomaly of the fixed station 20. In contrast, in the present embodiment, when an anomaly of the fixed station 20 is detected, correction data information is stopped at the same time so that an unstable operation of the drone 10 can be suppressed.

FIG. 8 is an example of a GUI for switching the moves and falls detection function between ON and OFF. As described above, the operation modes of the positioning system 100 include the mode of executing the processing of detecting an anomaly and the mode of not executing the processing of detecting an anomaly. This corresponds to the mode of turning ON the moves and falls detection function and the mode of turning OFF the moves and falls detection function, that have been described in Step 105 of FIG. 5. A slide switch 51 for switching such a moves and falls detection function between ON and OFF is displayed in the setting screen 50 shown in FIG. 8.

In this manner, ON/OFF of the moves and falls detection function may be selected on the GUI. For example, when the positioning system 100 is actually used, various cases such as a case where erroneous detection of a move or fall of the fixed station 20 occurs and a case where the user wishes to move the fixed station 20 are conceivable. At this time, by using a GUI such as that shown in FIG. 8, the user can easily switch the moves and falls detection function between ON and OFF. This makes it possible to improve the operability of the system.

It is noted that in the positioning system 100, it may be possible to switch not only the moves and falls detection function between ON and OFF but also other operation modes. The operation modes include, for example, a mode of constantly executing the processing of detecting an anomaly. This is a mode of constantly detecting a move or fall of the fixed station 20 even when correction data is not transmitted, for example. This makes it possible to constantly monitor the state of the fixed station 20 after the fixed station 20 is installed, and detect an anomaly of the fixed station 20 even when the drone 10 is not flying, for example.

The operation modes also include a mode of dynamically changing the threshold value to be used in the threshold value determination of each of the evaluation parameters in the moves and falls detection function (processing of detecting an anomaly). This is a mode of setting the threshold value according to the reception environment and/or the like. This makes it possible to set an optimal threshold value, and sufficiently suppress a frequency of erroneous detection of a move or fall of the fixed station 20. There are no other limitations on the type of operation modes. For example, an operation mode that enables the evaluation parameter to be used in the moves and falls detection to be selected, an operation mode that performs the anomaly detection using a learning model, and the like may be provided.

### Notification Means and Notification Processing

FIG. 9 are schematic diagrams each showing an example of the notification means for notifying of a move or fall of the fixed station 20. Hereinafter, the notification means for notifying, when an anomaly of the fixed station 20 including moves and falls is detected, the user of an occurrence of the anomaly, and a content of the notification processing that uses the notification means will be specifically described.

FIGS. 9A to 9D schematically show the drone 10, the transmitter 30, a notification device 55, and notification means provided in the fixed station 20, respectively. It is noted that the notification device 55 is a device introduced into the positioning system 100 for notifying of an occurrence of an anomaly of the fixed station 20. For example, a smartphone having a predetermined application installed therein or a dedicated device that notifies of an anomaly by vibration or sound is used as the notification device 55.

As shown in FIG. 9A, the drone 10 is equipped with speakers S and light-emitting elements L as the notification means. Further, as shown in FIG. 9B, the transmitter 30 is equipped with the speakers S, a vibration element V, and the light-emitting element L as the notification means. Also, a display D of the display unit 32 provided in the transmitter 30 is used as the notification means for displaying a GUI. As shown in FIG. 9C, in the notification device 55, the speaker S, the vibration element V, the light-emitting element L, and the display D are used as the notification means. Further, as shown in FIG. 9D, the fixed station 20 is equipped with, in the main body thereof, the notification means such as the speaker S and the light-emitting element L, for example.

The notification processing is processing of notifying of an occurrence of an anomaly due to a move of the fixed station 20 using at least one of the sound, vibration, light emission, or GUI. Specifically, the notification means mounted on the respective devices shown in FIG. 9 (speaker S, vibration element V, light-emitting element L (LED or the like), and display D) are used. For example, a notification signal that notifies of an occurrence of an anomaly is output from the processing unit 37 of the transmitter 30. The drone 10, the transmitter 30, the notification device 55, and the fixed station 20 that have received the notification signals notify of an occurrence of an anomaly by the notification means mounted thereon.

For example, the speaker S is used to reproduce a warning sound or audio that notifies of an occurrence of an anomaly. Further, vibration that notifies of an occurrence of an anomaly is generated by the vibration element V. Further, the light-emitting element emits light in a specific pattern to notify of an occurrence of an anomaly. Further, a GUI that notifies of an occurrence of an anomaly is displayed on the display D. This makes it possible to reliably notify the user of the occurrence of an anomaly.

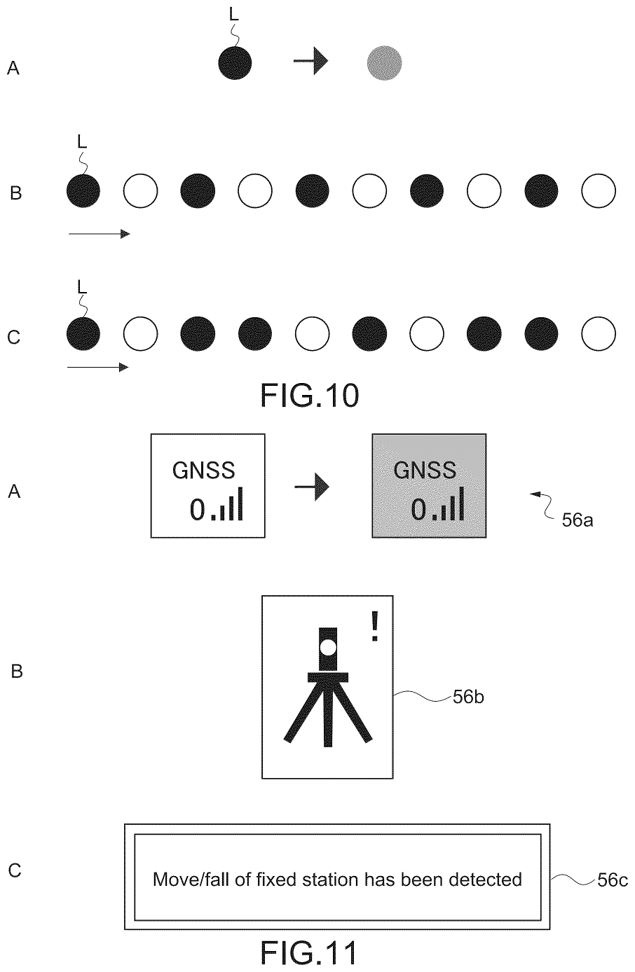

FIG. 10 are each an example of the light emission pattern for notifying of a move or fall of the fixed station 20. For example, an anomaly of the fixed station 20 is notified by the light-emitting elements (LED or the like) provided in the airframe of the drone 10, the main body of the transmitter 30, and the fixed station 20 being lit in a specific color or blinking in a specific pattern. By controlling the light emission pattern of the light-emitting elements L in this manner, it becomes possible to easily notify of an occurrence of an anomaly of the fixed station 20.

In FIG. 10A, a lighting color of the light-emitting element L changes. For example, when no anomaly has occurred, the light-emitting element L is lit in green, and when an anomaly has occurred, the same light-emitting element L is lit in red. Further, in FIG. 10B, the light-emitting element L is controlled to blink in the same color. Furthermore, in FIG. 10C, the light-emitting element L is controlled to blink in a specific pattern. Here, short lighting and long lighting are repeated alternately. There are no other limitations on the types of light emission patterns.

FIG. 11 each show an example of an error display for notifying of a move or fall of the fixed station 20. Error displays 56a to 56c respectively shown in FIGS. 11A to 11C are examples of the GUI that notifies of an anomaly of the fixed station 20 including moves and falls. These error displays 56a to 56c are displayed on the display unit 32 of the transmitter 30 and/or the display D of the notification device 55 when an anomaly of the fixed station 20 is detected.

In the error display 56a shown in FIG. 11A, when an anomaly is detected, a background color of an antenna display that shows a reception state of GNSS information is changed. In this manner, it is possible to notify of an occurrence of the anomaly by using the GUI that is also displayed in a normal operation screen and the like. Further, the error displays 56b and 56c respectively shown in FIGS. 11B and 11C are pop-up displays that are superimposed on the operation screen and/or the like, for example. In the error display 56b, an illustration expressing an occurrence of an error in the fixed station 20 is displayed, and in the error display 56b, a text describing an occurrence of an error in the fixed station 20 is displayed. There are no other limitations on the types of error displays.

In this manner, in the notification processing, an anomaly of the fixed station 20 is notified to the user using the sound, vibration, light emission, GUI, and the like. Any one of these notification methods may be executed, or a plurality of notification methods may be executed at the same time. Accordingly, it becomes possible for the user to recognize an occurrence of an anomaly in the fixed station 20, and to grasp in advance that a decrease in the positional accuracy of the drone 10 will occur so that the situation can be improved, for example.

Also in the notification processing, the method of notifying of an occurrence of an anomaly may be selected in accordance with an operation status of the drone 10. For example, the operation status of the drone 10 is determined from a user operation with respect to the transmitter 30 and/or information on the operation mode of the drone 10 (for example, autopilot mode, manual operation mode, or the like), and the notification method to be executed is selected according to the determination result.

For example, in a situation where the user is not operating the transmitter 30, it is assumed that the user is not near the transmitter 30. In such a case, the notification method by sound using the speaker S (auditory notification) is executed preferentially. This makes it possible to notify the user of an occurrence of an anomaly even when the user is not looking at the display D or the light-emitting element L.

Further, in a situation where the user is operating the transmitter 30, it is considered that the user is operating the transmitter 30 while checking the operation screen. In this case, the notification method by light emission using the light-emitting element L (visual notification) and the notification method by sound (auditory notification) are executed preferentially. This makes it possible to notify of an occurrence of an anomaly without inhibiting the display of the operation screen.

Furthermore, during a flight mission of the drone 10 in which the drone 10 is controlled automatically, it is considered that the user checks a progress of the mission and/or the like while looking at the operation screen. It is noted that the user does not need to operate the transmitter 30 during the flight mission. In this case, the notification method by a GUI using the display D (visual notification) and the notification method by sound (auditory notification) are executed preferentially. Accordingly, it becomes possible for the user to visually recognize the error display on the operation screen, and/or the like for sure, and be reliably notified of an occurrence of an anomaly, for example.

### Feedback of Erroneous Detection

In the processing of detecting an anomaly due to a move of the fixed station 20, an anomaly of the fixed station 20 may be detected erroneously. For example, there may be a case where, after an occurrence of an anomaly is notified by the notification processing, the state of the fixed station 20 is checked but there is no anomaly. In such a case, an anomaly of the fixed station 20 has been erroneously detected in the processing of detecting an anomaly. When the erroneous detection occurs in this manner, the user may transmit a feedback to the system side indicating that the last detection result has been an “erroneous detection.”

In the present embodiment, information indicating whether or not the detection of an anomaly has been an error is acquired. For example, after the notification processing is performed, a GUI used for inputting whether or not the detection has been an erroneous detection, and/or the like are displayed. Alternatively, a GUI for selecting an erroneous detection is provided in the setting items. Information input by the user using these GUIs becomes information indicating whether or not the detection of an anomaly has been an error.

When the detection of an anomaly has been an error, for example, processing of causing a learning model to learn that the detection of an anomaly has been an error is executed. In this case, data of the evaluation parameters used in the erroneous detection, and the like are stored together with a label indicating a non-anomalous state to be used as learning data for the learning model. Accordingly, the accuracy of the learning model is improved, and highly-accurate anomaly determination becomes possible.

Further, when the detection of an anomaly has been an error, it is also possible to dynamically change the threshold value used for the threshold value determination. For example, the erroneous detection may occur due to the reason that since the threshold value is low, noise elements caused by the shake or the like are detected. Therefore, by setting the threshold value to be high, it becomes possible to avoid the detection of noise elements and suppress erroneous detections.

In this processing, the threshold values for all of the evaluation parameters may be changed. Moreover, the threshold values for the evaluation parameters whose peak values are close to the threshold values (parameters slightly exceeding the threshold values) out of the evaluation parameters for which an anomaly has been determined may be changed preferentially. In this manner, by changing the threshold values at the time of an erroneous detection, the accuracy of the threshold value determination is improved, and erroneous detections can be suppressed.

As described above, in the information processing method according to the present embodiment, a move or fall of the fixed station 20 is detected as a state change of the fixed station 20 using the GNSS information received by the fixed station 20. Furthermore, when a move or fall of the fixed station 20 occurs, the notification processing for notifying of the occurrence of the move or fall of the fixed station 20 and the stop processing for stopping the output of correction data are executed. This makes it possible to detect a state change of the fixed station 20 with a simple configuration, and avoid unstable positioning.

The GNSS positioning by the RTK method requires a fixed station that transmits correction data from the ground in addition to a mobile station mounted on a drone. Further, since the coordinates of the mobile station are determined based on a relative distance with respect to the fixed station, the position of the fixed station becomes important. For example, when the fixed station moves or falls due to an external factor, the positioning accuracy of the mobile station may deteriorate. Therefore, when an anomaly occurs in the fixed station, a manipulator of the drone needs to swiftly cope with the anomaly.

As the method of detecting an anomaly of the fixed station, a method of providing a dedicated sensor or device in the fixed station is conceivable, but this method causes an increase in the size of the fixed station and lowering of portability. In addition, it is assumed that that the system design of the fixed station will become complicated. For example, when an IMU is mounted on the fixed station as a dedicated device for detecting moves and falls, a CPU for controlling the IMU needs to be provided separately, which may lead to an increase in the size and price of the fixed station. In addition, in general, a provider of a satellite reception device is often a company different from a developer of the drone that uses RTK, and thus it has been difficult to provide the moves and falls detection function to the satellite reception device itself.

The present embodiment adopts a mechanism for estimating the attitude and/or coordinates of the fixed station 20 based on satellite information (GNSS information) and observation information (evaluation parameters) obtained from the fixed station 20. This makes it possible to detect a move or fall of the fixed station 20 using only the information obtained by the GNSS reception unit 22, without using a dedicated device such as an IMU. In addition, since information of the mobile station 15 is not necessary, an anomaly of the fixed station 20 can be detected even when communication is not performed with the mobile station 15, for example.

This makes it possible to realize miniaturization of the fixed station 20 used in the RTK method. Further, by miniaturizing the fixed station 20, portability is improved, and the fixed station 20 can be arranged at various locations with ease. Furthermore, since a dedicated device is not necessary, it becomes possible to continue detecting an anomaly with high accuracy even in a case where the temperature of the installation location changes significantly, for example. This makes it possible to realize a moves and falls detection system that assumes a use outdoors and is resistant to a temperature change, for example.

In addition, by using the present technology, it becomes possible to realize a simple system at low costs. For example, by processing information from an existing satellite reception device as appropriate, it becomes possible to easily introduce the function of detecting an anomaly of the fixed station 20 including moves and falls. In addition, by using the light-emitting elements L, the speakers S, and the like provided in the fixed station 20, the transmitter 30, the drone 10, and the like, it is also possible to notify of an occurrence of an anomaly. This makes it possible to easily realize the positioning system 100 that is capable of detecting an anomaly of the fixed station 20 with a simple configuration and avoiding unstable positioning.

### Second Embodiment

An image display device according to a second embodiment of the present technology will be described. In descriptions hereinafter, descriptions on configurations and operations similar to those of the positioning system 100 described in the above embodiment will be omitted or simplified.

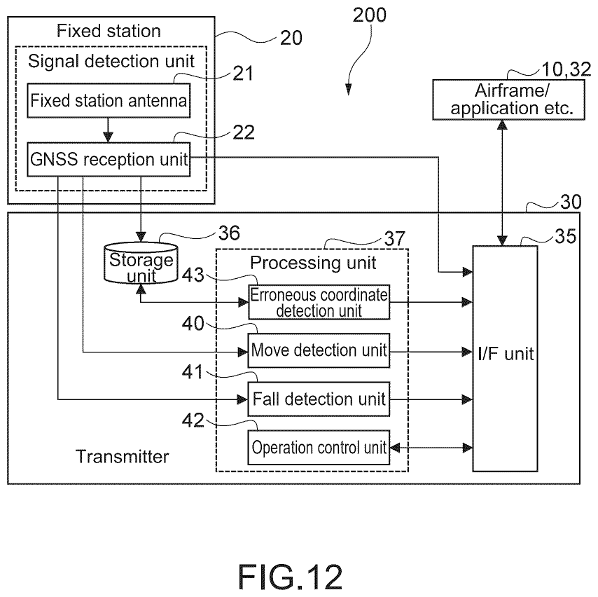

FIG. 12 is a block diagram showing a functional configuration example of a positioning system 200 according to the second embodiment. The positioning system 200 according to the present embodiment has an erroneous coordinate detection function for detecting an error of input coordinates, which are the positional coordinates of the fixed station 20 input by the user. Specifically, an erroneous coordinate detection unit 43 is provided as a functional block in the processing unit 37 of the transmitter 30. It is noted that, portions other than the erroneous coordinate detection unit 43 are configured similarly to those of the positioning system 100 described with reference to FIG. 2 and the like.

The erroneous coordinate detection unit 43 detects an error in the input coordinates of the fixed station 20 input by the user. The input coordinates are coordinates that are input as the setting coordinates to be set as the position of the fixed station 20. For example, latitude and longitude information is numerical data exceeding eight digits. When such data is manually input by the user, an input error and the like may occur. The erroneous coordinate detection unit 43 detects an error in the input coordinates (erroneous coordinates) due to such an input error and the like.

In the present embodiment, the erroneous coordinate detection unit 43 detects an error in the input coordinates based on the observational coordinates of the fixed station 20 measured by the fixed station 20 (GNSS reception unit 22). For example, when a distance (deviation) between the observational coordinates and the input coordinates is equal to or more than a threshold value, the input coordinates may be erroneous. In this case, the user is notified that the input coordinates are erroneous via a GUI and/or the like. Alternatively, components of the coordinates (latitude, longitude, altitude, and the like) may be directly compared to detect a component containing an input error.

Accordingly, the user can check the input coordinates, and when there is an error, correct the input coordinates so as to input accurate coordinates. Moreover, since there is also a possibility that the position of the fixed station 20 is deviated when the user checks the input coordinates and finds no error, the user may check the arrangement of the fixed station 20. It is noted that when there is no problem with the input coordinates or the arrangement of the fixed station, it is also possible to turn OFF the erroneous coordinate function assuming that the result of the erroneous coordinate detection has been an error.

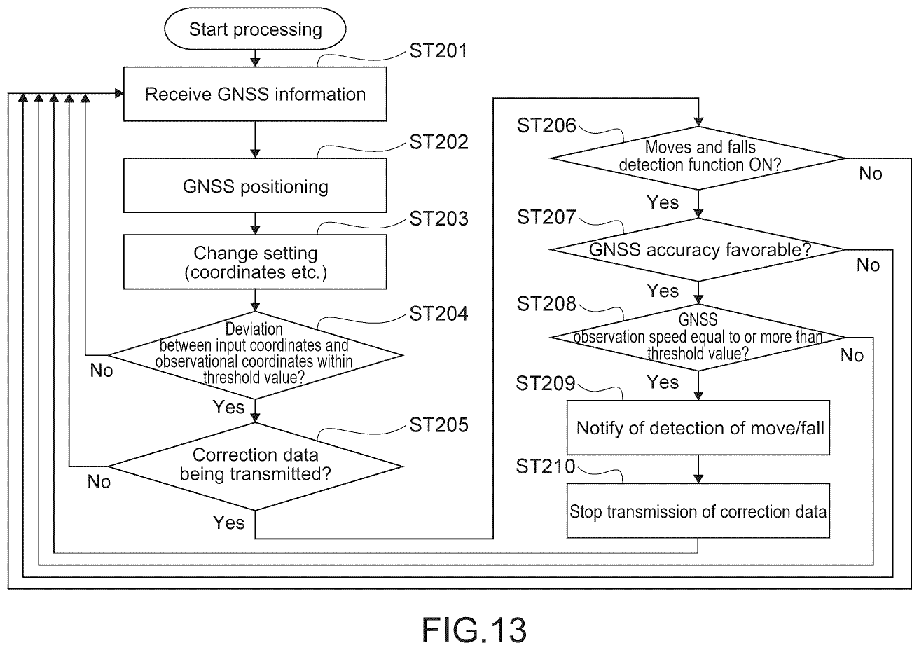

FIG. 13 is a flowchart showing an example of the operation of the positioning system 200 according to the second embodiment. The processing shown in FIG. 13 is obtained by adding processing of detecting an error of input coordinates by the erroneous coordinate detection unit 43 (Step 204) to the processing described with reference to FIG. 5. It is noted that the processing of Steps 201 to 203 is similar to the processing of Steps 101 to 103 shown in FIG. 5. Furthermore, the processing of Steps 205 to 210 is similar to the processing of Steps 104 to 109 shown in FIG. 5.

For example, when GNSS information is received (Step 201) and GNSS positioning is executed (Step 202), contents of the setting change and/or the like are read (Step 203). In Step 203, in addition to information on the operation mode of the fixed station 20 and/or the like, input coordinates input by the user are read.

When the contents of the setting change and/or the like are read, the erroneous coordinate detection unit 43 detects an error in the input coordinates (Step 204). Specifically, the input coordinates, which are the positional coordinates of the fixed station 20 that have been input by the user, are compared with the observational coordinates, which are the positional coordinates of the fixed station that have been calculated from the GNSS information received by the fixed station 20, to detect an error in the input coordinates. The comparison processing performed herein is processing of determining whether or not a deviation between the input coordinates and the observational coordinates is within a threshold value, as described above.

When the deviation between the input coordinates and the observational coordinates is larger than the threshold value (No in Step 204), there is a high possibility that there is an error in the input coordinates. Therefore, the processing returns to Step 102, and the value of the GNSS information reception of the fixed station 20 is referenced. In this case, the processing of detecting an anomaly is not executed. It is noted that when an error in the input coordinates is detected in Step 204, the notification processing for notifying to that effect is executed. This enables the user to perform the correction of the input coordinates, check of the arrangement of the fixed station 20, and the like.

In this manner, in the present embodiment, when there is an error in the input coordinates, the processing of detecting an anomaly is not executed. For example, in a state where erroneous input coordinates are used, the positioning by the RTK method may not be established or the positioning may likely to become unstable. Therefore, the correction data itself should not be transmitted. For this reason, an anomaly of the fixed station 20 is detected after the error in the input coordinates is corrected. Accordingly, the task of the user before transmission of correction data is not inhibited, and it becomes possible to realize a user-friendly system.

Moreover, when the deviation between the input coordinates and the observational coordinates is smaller than the threshold value (Yes in Step 204), the processing of Step 205 and subsequent steps (Steps 205 to 210) is executed assuming that the values of the input coordinates are correct. Accordingly, it becomes possible to perform processing that uses accurate input coordinates, and detect a move or fall of the fixed station 20 with high accuracy.

### Third Embodiment

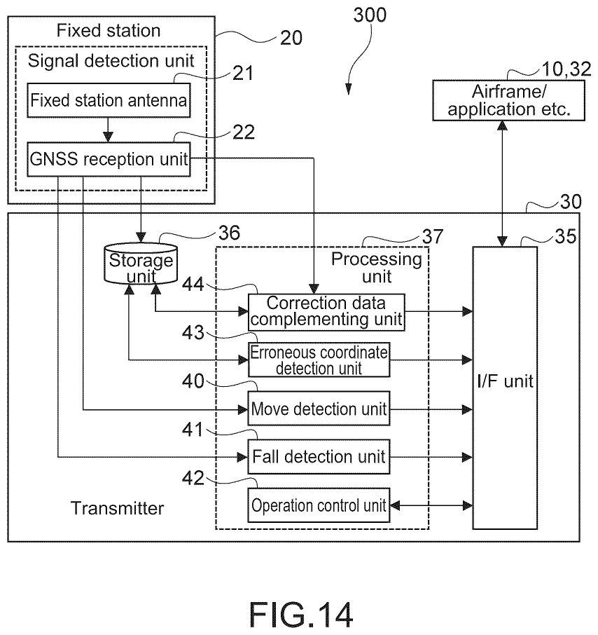

FIG. 14 is a block diagram showing a functional configuration example of a positioning system 300 according to a third embodiment. The positioning system 300 according to the present embodiment has a complementing function for complementing correction data output from the GNSS reception unit 22 of the fixed station 20. Specifically, a correction data interpolation unit 44 is provided as a functional block in the processing unit 37 of the transmitter 30. It is noted that portions other than the correction data interpolation unit 44 are configured similarly to those of the positioning system 200 described with reference to FIG. 12 and the like The correction data interpolation unit 44 adds missing data to the correction data output from the GNSS reception unit 22, and outputs the data. For example, the GNSS reception unit 22 may not be able to output required correction data depending on its specifications. In this case, the correction data is complemented using data stored in advance in the storage unit 36 of the transmitter 30.

For example, as the satellite reception device to become the GNSS reception unit 22, there are products having a restriction that self-position GNSS positioning and generation of correction data cannot be executed at the same time. The correction data output from such products does not include position information (observational coordinates) of the fixed station 20. Meanwhile, there are cases where the observational coordinates of the fixed station 20 are required as the correction data. This is information corresponding to type numbers 1005 and 1006 of RTCM messages.

In this regard, the correction data interpolation unit 44 adds data of the last observational coordinates stored in the storage unit 36 to the correction data output from the GNSS reception unit 22. Accordingly, the missing data is complemented, and it becomes possible to output correction data required by the system. In this manner, by providing the correction data interpolation unit 44, it becomes possible to introduce the function of detecting an anomaly of the fixed station 20 including moves and falls also in a system that uses a device having a restriction on the output of correction data.

### Other Embodiments

The present technology is not limited to the embodiments described above, and various other embodiments can be realized.

The embodiments above have described the positioning system for positioning a moving object such as a drone, a vehicle, or a construction machinery. The positioning target of the positioning system is not limited to a moving object. For example, the present technology may be applied to positioning of a form terminal carried by a user, positioning of a surveying tool, and the like. In addition, the present technology can be applied to any positioning system that uses the positioning by the RTK method.

The descriptions above have been given on the case where the information processing method according to the present technology is executed by the processing unit mounted on the transmitter or the like. However, it is also possible to execute the information processing method and program according to the present technology by a computer mounted on the processing unit and another computer communicable via a network or the like.

That is, the information processing method and program according to the present technology can be executed not only in a computer system constituted of a single computer, but also in a computer system in which a plurality of computers operate in conjunction with one another. It is noted that in the present disclosure, the system refers to an aggregation of a plurality of constituent elements (apparatuses, modules (components), and the like), and whether or not all of the constituent elements are within the same housing is irrelevant. Accordingly, a plurality of apparatuses that are housed in separate housings and are connected via a network and a single apparatus in which a plurality of modules are housed in a single housing are both systems.

The execution of the information processing method and program according to the present technology by the computer system includes, for example, both of a case where the processing of detecting a state change of the fixed station and/or the processing of executing, when a state change of the fixed station is detected, at least one of the notification processing or the stop processing are executed by a single computer and a case where the respective processing is executed by different computers. Moreover, the execution of the respective processing by a predetermined computer includes causing other computers to execute a part or all of the processing and acquiring results thereof.

Therefore, the information processing method and program according to the present technology can also be applied to a configuration of cloud computing in which a plurality of apparatuses share and cooperate to process a single function via a network.

Of the feature portions according to the present technology described above, at least two of the feature portions can be combined. In other words, the various feature portions described in the respective embodiments may be arbitrarily combined without distinction of the embodiments. Moreover, the various effects described above are mere examples and are not limited, and other effects may also be exerted.

In the present disclosure, the terms “same”, “equal”, “orthogonal”, and the like are concepts including “substantially the same”, “substantially equal”, “substantially orthogonal”, and the like. For example, a state within a predetermined range (e.g., range within ±10%) that uses “completely the same”, “completely equal”, “completely orthogonal”, and the like as a reference is also included.

It is noted that the present technology can also take the following configurations.

(1) An information processing method executed by a computer system, including:
detecting a state change of a fixed station which outputs correction data used in GNSS positioning on the basis of GNSS information received by the fixed station; and
executing, when the state change of the fixed station is detected, at least one of notification processing for notifying of an occurrence of the state change of the fixed station or stop processing for stopping the output of the correction data.
   (2) The information processing method according to (1), in which
in processing of detecting the state change of the fixed station, at least one of a move of the fixed station or a fall of the fixed station is detected.
   (3) The information processing method according to (1) or (2), in which
in processing of detecting the state change of the fixed station, the state change of the fixed station is detected on the basis of an evaluation parameter including at least one of a position of the fixed station, a speed of the fixed station, an acceleration of the fixed station, an angular speed of the fixed station, or positional accuracy of the fixed station, that has been calculated from the GNSS information received by the fixed station.
   (4) The information processing method according to (3), in which
in the processing of detecting the state change of the fixed station, presence or absence of the state change of the fixed station is determined by threshold value determination with respect to the evaluation parameter.
   (5) The information processing method according to (4), in which
the evaluation parameter includes the speed of the fixed station, and
in the threshold value determination, it is determined that the state change of the fixed station has occurred when the speed of the fixed station exceeds a first threshold value.
   (6) The information processing method according to (4) or (5), in which
the evaluation parameter includes the position of the fixed station, and
in the threshold value determination, it is determined that the state change of the fixed station has occurred when a deviation between a position set for the fixed station and a position of the fixed station calculated as the evaluation parameter exceeds a predetermined threshold range.
   (7) The information processing method according to any one of (4) to (6), in which
in the processing of detecting the state change of the fixed station, a threshold value used for the threshold value determination is varied in accordance with a reception environment of the GNSS information in the fixed station.
   (8) The information processing method according to (3), in which
in the processing of detecting the state change of the fixed station, presence or absence of the state change of the fixed station is determined by a learning model that uses the evaluation parameter as an input.
   (9) The information processing method according to (8), further including:
acquiring information indicating whether or not the detection of the state change of the fixed station is an error; and
causing, when the detection of the state change of the fixed station is an error, the learning model to learn that the detection of the state change of the fixed station is an error.
   (10) The information processing method according to any one of (1) to (9), further including:
acquiring information that designates an operation mode related to an operation of the fixed station; and
executing processing of detecting the state change of the fixed station in accordance with the designated operation mode.
   (11) The information processing method according to (10), in which
the operation mode includes a mode of outputting the correction data and a mode of not outputting the correction data, and
the processing of detecting the state change of the fixed station is executed when the mode of outputting the correction data is designated, and the processing of detecting the state change of the fixed station is not executed when the mode of not outputting the correction data is designated.
   (12) The information processing method according to (11), in which
the stop processing is processing of designating the mode of not outputting the correction data, and
when the stop processing is executed, the output of the correction data is stopped until the mode of outputting the correction data is designated.
   (13) The information processing method according to any one of (10) to (12), in which
the operation mode includes a mode of executing the processing of detecting the state change of the fixed station and a mode of not executing the processing of detecting the state change of the fixed station.
   (14) The information processing method according to any one of (10) to (13), in which
the operation mode includes a mode of constantly executing the processing of detecting the state change of the fixed station.
   (15) The information processing method according to any one of (1) to (14), in which
processing of detecting the state change of the fixed station is not executed when positional accuracy of the fixed station is lower than a second threshold value.
   (16) The information processing method according to any one of (1) to (15), in which
the notification processing includes notifying of the occurrence of the state change of the fixed station using at least one of sound, vibration, light emission, or a graphical user interface.
   (17) The information processing method according to any one of (1) to (16), in which
the correction data is used in positioning of a mobile station mounted on a drone, and
the notification processing includes selecting a method of notifying of the occurrence of the state change of the fixed station in accordance with an operation status of the drone.
   (18) The information processing method according to any one of (1) to (17), further including:
comparing input coordinates which are positional coordinates of the fixed station input by a user and observational coordinates which are positional coordinates of the fixed station calculated from the GNSS information received by the fixed station, to detect an error in the input coordinates; and
not executing processing of detecting the state change of the fixed station when there is an error in the input coordinates.
   (19) A fixed station which outputs correction data used in GNSS positioning, including:
an antenna;
a reception unit which receives GNSS information via the antenna;
a change detection unit which detects a state change of the fixed station on the basis of the GNSS information; and
an operation control unit which executes, when the state change of the fixed station is detected, at least one of notification processing for notifying of an occurrence of the state change of the fixed station or stop processing for stopping the output of the correction data.
   (20) A program for causing a computer system to execute the steps of:
detecting a state change of a fixed station which outputs correction data used in GNSS positioning on the basis of GNSS information received by the fixed station; and
executing, when the state change of the fixed station is detected, at least one of notification processing for notifying of an occurrence of the state change of the fixed station or stop processing for stopping the output of the correction data.

### REFERENCE SIGNS LIST

10 drone
15 mobile station
20 fixed station
22 GNSS reception unit
37 processing unit
40 move detection unit
41 fall detection unit
42 operation control unit
43 erroneous coordinate detection unit
44 correction data interpolation unit
100, 200, 300 positioning system

1. An information processing method executed by a computer system, comprising:
detecting a state change of a fixed station which outputs correction data used in GNSS positioning on a basis of GNSS information received by the fixed station; and
executing, when the state change of the fixed station is detected, at least one of notification processing for notifying of an occurrence of the state change of the fixed station or stop processing for stopping the output of the correction data.

2. The information processing method according to claim 1, wherein
in processing of detecting the state change of the fixed station, at least one of a move of the fixed station or a fall of the fixed station is detected.

3. The information processing method according to claim 1, wherein
in processing of detecting the state change of the fixed station, the state change of the fixed station is detected on the basis of an evaluation parameter including at least one of a position of the fixed station, a speed of the fixed station, an acceleration of the fixed station, an angular speed of the fixed station, or positional accuracy of the fixed station, that has been calculated from the GNSS information received by the fixed station.

4. The information processing method according to claim 3, wherein
in the processing of detecting the state change of the fixed station, presence or absence of the state change of the fixed station is determined by threshold value determination with respect to the evaluation parameter.

5. The information processing method according to claim 4, wherein
the evaluation parameter includes the speed of the fixed station, and
in the threshold value determination, it is determined that the state change of the fixed station has occurred when the speed of the fixed station exceeds a first threshold value.

6. The information processing method according to claim 4, wherein
the evaluation parameter includes the position of the fixed station, and
in the threshold value determination, it is determined that the state change of the fixed station has occurred when a deviation between a position set for the fixed station and a position of the fixed station calculated as the evaluation parameter exceeds a predetermined threshold range.

7. The information processing method according to claim 4, wherein
in the processing of detecting the state change of the fixed station, a threshold value used for the threshold value determination is varied in accordance with a reception environment of the GNSS information in the fixed station.

8. The information processing method according to claim 3, wherein
in the processing of detecting the state change of the fixed station, presence or absence of the state change of the fixed station is determined by a learning model that uses the evaluation parameter as an input.

9. The information processing method according to claim 8, further comprising:
acquiring information indicating whether or not the detection of the state change of the fixed station is an error; and
causing, when the detection of the state change of the fixed station is an error, the learning model to learn that the detection of the state change of the fixed station is an error.

10. The information processing method according to claim 1, further comprising:
acquiring information that designates an operation mode related to an operation of the fixed station; and
executing processing of detecting the state change of the fixed station in accordance with the designated operation mode.

11. The information processing method according to claim 10, wherein
the operation mode includes a mode of outputting the correction data and a mode of not outputting the correction data, and
the processing of detecting the state change of the fixed station is executed when the mode of outputting the correction data is designated, and the processing of detecting the state change of the fixed station is not executed when the mode of not outputting the correction data is designated.

12. The information processing method according to claim 11, wherein
the stop processing is processing of designating the mode of not outputting the correction data, and
when the stop processing is executed, the output of the correction data is stopped until the mode of outputting the correction data is designated.

13. The information processing method according to claim 10, wherein
the operation mode includes a mode of executing the processing of detecting the state change of the fixed station and a mode of not executing the processing of detecting the state change of the fixed station.

14. The information processing method according to claim 10, wherein
the operation mode includes a mode of constantly executing the processing of detecting the state change of the fixed station.

15. The information processing method according to claim 1, wherein
processing of detecting the state change of the fixed station is not executed when positional accuracy of the fixed station is lower than a second threshold value.

16. The information processing method according to claim 1, wherein
the notification processing includes notifying of the occurrence of the state change of the fixed station using at least one of sound, vibration, light emission, or a graphical user interface.

17. The information processing method according to claim 1, wherein
the correction data is used in positioning of a mobile station mounted on a drone, and
the notification processing includes selecting a method of notifying of the occurrence of the state change of the fixed station in accordance with an operation status of the drone.

18. The information processing method according to claim 1, further comprising:
comparing input coordinates which are positional coordinates of the fixed station input by a user and observational coordinates which are positional coordinates of the fixed station calculated from the GNSS information received by the fixed station, to detect an error in the input coordinates; and
not executing processing of detecting the state change of the fixed station when there is an error in the input

19. A fixed station which outputs correction data used in GNSS positioning, comprising:
an antenna;
a reception unit which receives GNSS information via the antenna;
a change detection unit which detects a state change of the fixed station on a basis of the GNSS information; and
an operation control unit which executes, when the state change of the fixed station is detected, at least one of notification processing for notifying of an occurrence of the state change of the fixed station or stop processing for stopping the output of the correction data.

20. A program for causing a computer system to execute the steps of:
detecting a state change of a fixed station which outputs correction data used in GNSS positioning on a basis of GNSS information received by the fixed station; and
executing, when the state change of the fixed station is detected, at least one of notification processing for notifying of an occurrence of the state change of the fixed station or stop processing for stopping the output of the correction data.
